(19) United States
(12) Patent Application Publication
(10) Pub. No.: US 2006/0027299 A1
(43) Pub. Date: Feb. 9, 2006

(54) Bicycle inner tube with interchangeable valves and methods for distribution thereof

(76) Inventor: Jeff Keller, Logan, UT (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 11/196,657

(22) Filed: Aug. 3, 2005

Related U.S. Application Data
(60) Provisional application No. 60/598,589, filed on Aug. 3, 2004.

(51) Int. Cl. B60C 5/04

(52) U.S. Cl. 152/511; 137/231; 29/221.5

(57) ABSTRACT

A bicycle inner tube including an annular envelope defining an interior gas compartment and a connecting means operatively associated with the annular envelope. The connecting means is configured to selectively engage either of at least two different styles or sizes of inflation valve. The two most commonly available styles of inflation valve used in the bicycle arts are Schrader valves and Presta valves, however, other valve styles as well as various sizes of a valve style are suitable for implementation with this invention. The selective removable engagement between the connecting means and a suitable valve provides for substantially airtight fluid communication between the interior gas compartment of the inner tube and the selected inflation valve. The connecting means may include a threaded aperture formed in the annular envelope and configured to selectively and threadably engage an attachment structure associated with each of the various types or styles of inflation valve. A seal may be operatively associated with the threaded aperture.

### RELATED APPLICATION DATA

This application claims benefit of U.S. Provisional Patent Application Ser. No. 60/598,589, filed Aug. 3, 2004, entitled BICYCLE INNER TUBE WITH INTERCHANGEABLE VALVES AND METHODS FOR DISTRIBUTION THEREOF, which application is incorporated herein by reference in its entirety.

### TECHNICAL FIELD

The present invention is directed toward inflation valves for a bicycle inner tube and a method for distribution of same. More particularly, the present invention is directed toward valves for a bicycle inner tube which can accept interchangeable valves of different types and methods for the distribution packaging and marketing of such inner tubes and valves.

### BACKGROUND ART

A typical bicycle wheel features four major components: a hub, a rim connected to the hub with spokes, a tire, and an inner tube. Typically, the rim is made of metal, a composite material, or plastic and is rigid. The rim will have an appropriate width and diameter suitable for the type of bicycle for which it is designed. A variety of different types of bicycle tires can be fabricated which have various tread patterns suitable for specific bicycling purposes, and which generally feature a reinforced bead which engages with the rim and a rubber tread portion. In most bicycle wheels, an inner tube is positioned inside the bicycle tire and over the perimeter of the rim such that the inner tube can receive pressurized air or other gas and thus inflate the tire. Although tubeless tires similar in design to those used with passenger cars are known in the bicycling arts, the vast majority of all bicycles sold in the world feature inner tubes.

Air is supplied to an inner tube through a special inflation valve. The valve extends from the inner tube through an aperture in the rim. An inflation end of the valve is thus accessible to the bicycle user for inflation purposes. Bicycle valves have internal mechanisms of various types which allow the bicycle user or a maintenance technician to force pressurized air into the inner tube by means of a compressed air source or a pump. The internal mechanisms of the valve also substantially prevent the pressurized air in the inner tube from escaping when inflation is complete. Prior art bicycle inner tubes have the valve permanently bonded to the tube structure so a tube and valve are installed and replaced as a unit.

Bicycle inner tube valves are available in at least three well recognized configurations. By a large margin the two most popular types of bicycle valve used throughout the world are the Presta valve and the Schrader valve. The stem diameter and valve configuration of Presta, Schrader, and other valve types differ from each other. Thus, the connection between a pump or other pressurized air supply which forms a seal between the supply and the valve must be specifically designed for a given type of valve to ensure that a proper seal is formed during the inflation process. Pump connectors often are not interchangeable; for example, a pump connector designed for a specific type of valve, a Presta valve for instance, may not be suitable for use with another type of valve, such as a Schrader valve. Thus, the bicycle owner or shop technician who works with multiple types of valving must either obtain multiple specialized pumps or take the time to switch out the connectors on the inflation air source each time a differently valved inner tube is inflated.

Perhaps the most routine maintenance activity performed on a bicycle is the repair of a puncture to the inner tube. Often the puncture or cut in an inner tube is sufficiently severe that repair is not practical and the inner tube must be replaced. If the damage to the inner tube results from a cut or tear to the tube body and the valve is unaffected, the valve must be thrown away with the damaged tube since the two are permanently bonded together. Similarly, it is possible that the valve itself will become damaged through an accident or normal wear and tear. Although this maintenance task is less common than the replacement of a punctured inner tube, valve damage is still a frequently encountered occurrence. Presently, the replacement of an inner tube valve involves replacing the entire inner tube, since the two components are bonded together.

Since the replacement of a damaged bicycle inner tube is the most common maintenance performed on a bicycle, inner tubes are the most commonly sold maintenance product or component in a typical retail bicycle shop. Inner tube sales can be the primary source of recurring or repeat visits from customers. Selecting an appropriately sized inner tube and valve combination presently involves searching through the store's inner tube inventory, and finding the appropriate sized inner tube and valve combination can be confusing. For example, Presta valves are available in at least 4 different valve lengths, with each length being designed for use with a different rim style. Inner tubes are available in at least three weights: thorn resistant, standard, and ultra light. Finally, there are numerous combinations of different rim diameters and tire widths which must be matched with an appropriate inner tube. Thus retail bicycle store employees often spend inordinate amounts of time assisting customers with inner tube selection.

Presently, inner tubes are sold in nondescript, cardboard boxes. Because a prior art inner tube has a permanently bonded valve, tubes are generally rolled in a flat coil around the valve, secured with a rubber band, and placed in the box. The user, who may want a spare tube included in the equipment taken along for a bicycle ride will typically discard the box and any associated marketing materials and place the tube in a saddle bag, backpack, repair kit, or other compartment associated with the bicycle. All too often replacement tubes carried in the field can be punctured or ruined by tools or other objects over the course of a number of rides. Also, the permanently bonded valve of a prior art tube can wear through the tube after a period of time stored in a saddle bag. The boxes associated with prior art inner tubes are also simply utilitarian, and do not provide any distinct marketing or distribution advantages. Typical tube boxes can be twice as large as necessary, so storage space is not efficiently used. Retail bicycle shops must carry a large variety of inner tubes in different sizes and, as discussed above, having different valve types. The inventory is often simply stacked in a convenient location in the bike shop.

The present invention is directed toward overcoming one or more of the problems discussed above.

### SUMMARY OF THE INVENTION

One aspect of the present invention is a bicycle inner tube including an annular envelope defining an interior gas compartment and a connecting means operatively associated with the annular envelope. The connecting means is configured to selectively engage either of at least two different styles of inflation valve. The two most commonly available styles of inflation valve used in the bicycle arts are Schrader valves and Presta valves, however, other valve styles are suitable for implementation with this invention. The selective removable engagement between the connecting means and a suitable valve provides for substantially airtight fluid communication between the interior gas compartment of the inner tube and the selected inflation valve. The connecting means may include a threaded aperture formed in the annular envelope and configured to selectively and threadably engage an attachment structure associated with each of the various types or styles of inflation valve. A seal may be operatively associated with the threaded aperture. The seal may be a gasket, o-ring, or other sealing structure, or a compound, tape, thread, or other substance which may be applied to the threaded aperture to achieve a substantially airtight seal.

The connecting means may also include a hollow threaded stud in removable threaded engagement with the threaded aperture. The hollow threaded stud may be configured to selectively and threadably engage the attachment structure associated with each of at least two different styles of inflation valve as described above.

Alternatively, the connecting means may include a threaded semi-stem configured to selectively and removably threadably engage the attachment structure associated with each of the at least two different styles of inflation valve. The threaded semi-stem may be threaded on the exterior defining a male engagement surface and on the interior defining a female engagement surface. The attachment structures of suitable valves of various types, Presta and Schrader valves, for example, may be configured to engage one or the other of the male or female engagement surfaces. The threaded semi-stem may also be operatively associated with a seal as described above.

Another aspect of the present invention is a bicycle inner tube including an annular envelope defining an interior gas compartment with a threaded aperture opening through the annular envelope. In addition, a hollow threaded stud may be included in removable threaded engagement with the threaded aperture. Also, an inflation valve may be included in removable threaded engagement with the hollow threaded stud such that substantially airtight fluid communication exists between the interior gas compartment and the inflation valve. This aspect of the present invention may also include a seal between the threaded aperture and the hollow threaded stud and a seal between the hollow threaded stud and the inflation valve. The inflation valve may be of any suitable type including a Presta valve or a Schrader valve. The threaded aperture may be formed flush with the surface of the annular envelope or formed in a semi-stem extending from the annular envelope.

Another aspect of the present invention is a method of providing a bicycle inner tube and valve to a user of bicycle inner tubes. The method includes providing an inner tube having connecting means as described above. The method also includes providing an inflation valve of a first style which includes an attachment structure configured to be selectively engaged with the connecting means. The method further includes providing an inflation valve of a second style having a similar attachment structure for engagement with the connecting means. The inner tube and first and second inflation valves are provided to consumers as separate items, thus consumers have the ability to select a suitable inner tube for their use and match it with a suitable valve from a wide variety of styles and sizes. In addition, if an inner tube or valve alone needs to be replaced or exchanged, the consumer may purchase the damaged part while retaining for continued use the undamaged component.

Another embodiment of the present invention is a method of distributing bicycle inner tubes comprising providing a first display of inner tubes, each inner tube having connecting means operatively associated with the tube for selectively connecting each of at least two types of inflation valves and providing a second display of at least two types of inflation valves, each type of valve having an attachment structure which can mate with the connection apparatus of the inner tube in a substantially airtight connection.

Another embodiment of the present invention is a method of packaging a bicycle inner tube comprising encasing the inner tube in a conforming thermoplastic package.

### BRIEF DESCRIPTION OF THE DRAWINGS

FIG. 1 is a plan view of a prior art inner tube;

FIG. 2A is a plan view of an inner tube consistent with the present invention featuring a connecting means suitable for engagement with a replaceable and interchangeable Presta valve;

FIG. 2B is a plan view of the inner tube of FIG. 1 showing alternative engagement with a replaceable and interchangeable Schrader valve;

FIG. 3 is a plan perspective view of an inner tube consistent with the present invention featuring a semi-stem connecting means suitable for engagement with either a Schrader or Presta valve;

FIG. 4 is a cutaway plan view of an inner tube consistent with the present invention featuring a hollow stud operatively disposed between the connecting means and a Schrader valve;

FIG. 5 is a cutaway plan view of an inner tube consistent with the present invention featuring a hollow stud operatively disposed between the connecting means and a Presta valve;

FIG. 6 is a perspective view of an alternative distribution apparatus;

FIG. 7 is a perspective view of an alternative distribution apparatus;

FIG. 8 is a perspective view of an alternative distribution apparatus;

FIG. 9 is a perspective view of an alternative distribution apparatus; and

FIG. 10 is a perspective view of an alternative distribution apparatus;

### DETAILED DESCRIPTION OF THE PREFERRED EMBODIMENT

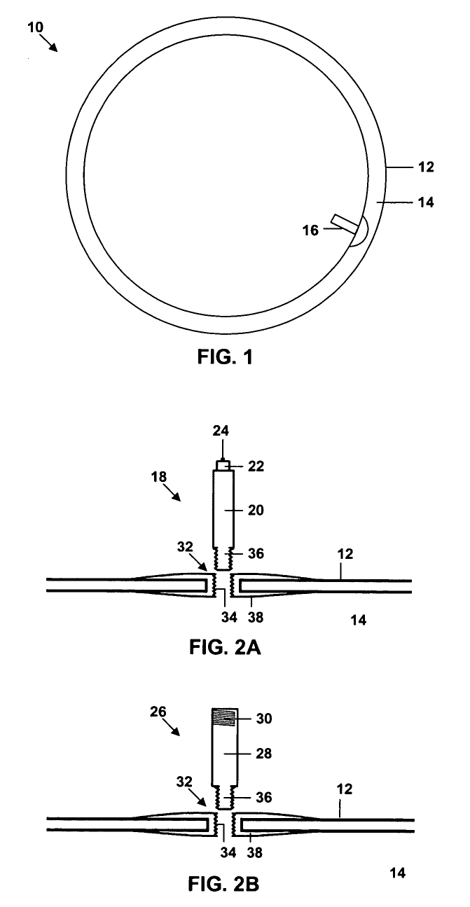

A typical bicycle inner tube suitable for use in conjunction with a bicycle tire is shown in FIG. 1. Other inner tube designs that do not have an annular envelope are possible, but not common. The inner tube 10 consists of an annular envelope 12 defining an interior gas compartment 14. The annular envelope 12 can be manufactured from any reasonably airtight material, however, virtually all modern bicycle inner tubes are manufactured from a synthetic rubber such as butyl rubber. Alternative materials such as Mylar are possible substitutions for butyl rubber.

Typical prior art bicycle inner tubes feature an inflation valve 16 which is permanently bonded to the annular envelope 12 of the inner tube 10. The inflation valve 16 provides a fluid pathway between the interior gas compartment and an external pressurized air source (not shown). The inflation valve 16 includes internal mechanisms which allow pressurized air to be forced into the interior gas compartment 14 of the inner tube 10, and which also substantially prohibit the leaking of pressurized air from the inner tube 10 when the pressurized air source is removed. Representative apparatus for airflow control which can be associated with the inflation valve 16 include spring loaded or pressure activated check valves of various configurations.

Two types of inflation valves dominate the modern day inner tube marketplace. The first type is known in the industry as a Presta valve. This type of valve is also known as a “French valve”. A prior art Presta valve is permanently bonded to the annular envelope 12 of an inner tube 10 such as is depicted in FIG. 1. A novel removable Presta valve 18 suitable for use in the present invention is shown schematically in FIG. 2A. A Presta valve 18 has a relatively narrow body 20, a valve capping nut 22, and an external valve actuating pin 24.

Presta valves are relatively light and narrow, and thus do not require a large hole in the bicycle rim for installation. Presta valves typically do not rely on an internal spring to seal the valve after inflation, therefore, Presta valves can be somewhat easier to pump with a hand pump. Accordingly, Presta valves predominate the high performance bicycle tube market.

The second popular valve style commonly used on bicycle inner tubes is a Schrader valve. Schrader valves are also known as “automotive style valves”. A prior art Schrader valve will also be permanently bonded to an inner tube 10 as shown in FIG. 1. A novel removable Schrader valve 26 suitable for use in the present invention is shown schematically in FIG. 2B. A Schrader valve 26 also has a body 28 which is somewhat wider than the body of a Presta valve 18. A typical Schrader valve 26 is threaded at the inflation end with the threads 30 being designed to receive a separate valve cap. The valve actuating pin of a Schrader valve is internal, and is not shown on FIG. 2B. Also, Schrader valves generally have spring loaded valving mechanisms which can make them somewhat harder to use with a hand bicycle pump. Since Schrader valves are automotive style, bicycles featuring inner tubes with Schrader valves can be inflated using typical automotive compressed air supplies such as the tire inflation devices commonly available at filling stations and garages. These types of devices, designed for automotive use, cannot be used to inflate a Presta valve inner tube without a special adapter. Likewise, a bicycle pump or other compressed air source designed for use with Presta valves cannot be used to inflate a Schrader valve tire without a corresponding adapter. Schrader valves are typically used on the wheels of children's bicycles, department store bicycles, other lower end bicycles, and utility bicycles.

Also shown in FIG. 2A and FIG. 2B is the portion of the annular envelope 12 of an inner tube in the immediate vicinity of an inflation valve. The inner tube annular envelope 12 of the present invention is provided with a connecting means 32. The connecting means 32 allows for the connection of a Presta valve 18, a Schrader valve 26, or any other valve type or style prepared in accordance with the present invention to the annular envelope 12 of an inner tube. The connection between the valve 18, 26 and the annular envelope 12 through the connecting means 32 must be substantially airtight. Preferably, the connection between an inflation valve and the tube is easily reversible, allowing the exchange or replacement of a valve 18, 26. In one embodiment of the invention, the connecting means 32 is suitable for connecting either a Presta valve 18 or a Schrader valve 26 to the same tube at different times according to the needs and desires of the bicycle owner.

The specific embodiment of the present invention shown in FIG. 2A and FIG. 2B features a connecting means 32 which consists of a threaded aperture 34 defining an opening between the interior gas compartment 14 and the exterior of the annular envelope 12. A mating threaded attachment structure 36 is provided at the end of the valve 18, 26 opposite the inflation end. As shown in FIG. 2A and FIG. 2B, the threaded attachment structure 36 can be incorporated into either a Presta valve 18 or a Schrader valve 26. To accomplish the attachment of a valve 18, 26 in the embodiment depicted in FIG. 2A and FIG. 2B, the bicycle owner or technician merely screws the threaded attachment structure 36 into mating engagement with the threaded aperture 34. An airtight seal can be achieved in numerous ways, for example, the respective threads of the attachment structure 36 and threaded aperture 34 can be machined with sufficient precision to assure an airtight seal. Tapered threading can be used to assist with an airtight seal. Alternatively, a sealing compound such as a glue, cement, polymer or oil can be applied to the threads to assure an airtight seal. Teflon tape or other solid sealing agents can be placed on the threads of the attachment structure 36 or threaded aperture 34 prior to the threaded engagement. Also, a small o-ring or gasket, not shown on FIG. 2A or FIG. 2B, can be operatively disposed between the body 20, 28 of the valve and an exterior surface of the threaded aperture 34.

Although the embodiment depicted in FIG. 2A and FIG. 2B and described above features a connecting means 32 which consists of a threaded aperture 34, other structures can form suitable connecting means 32. In particular, airtight quick connects such as are used in conjunction with pneumatic hoses, barbed stems, an interference fit into the tube body, a self tapping stem or self threading orifice, a barbed orifice, a locking slip connect, or similar devices could be adapted to be used as a connecting means 32 consistent with the present invention.

The annular envelope 12 of a typical inner tube is typically made of thin and elastic butyl rubber. Therefore, the threaded aperture 34 preferably will be formed in a reinforced section 38 of the annular envelope 12.

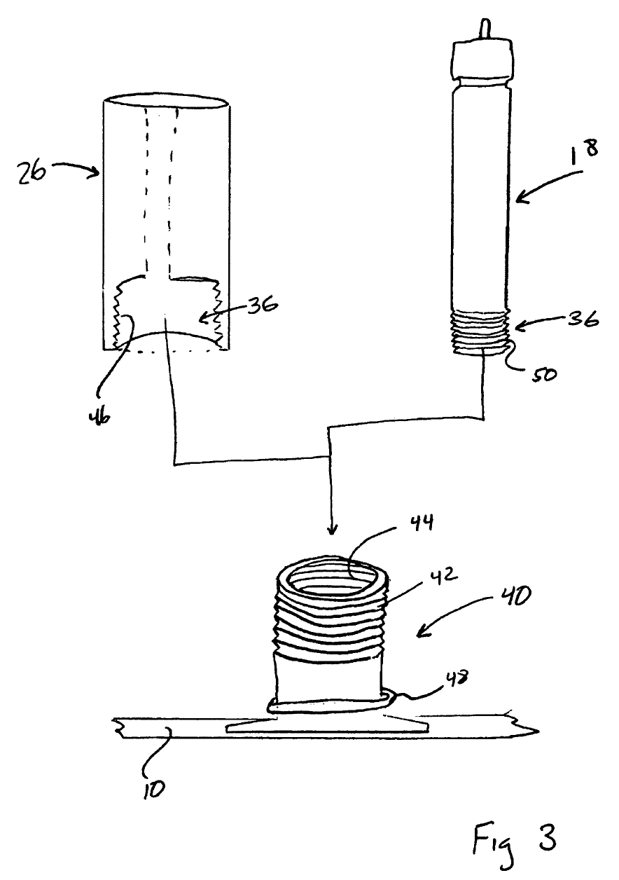

Alternative connecting means 32 other than the embodiment shown in FIG. 2A and FIG. 2B are within the scope of the present invention. In particular, the connecting means 32 can be formed as a short semi-stem 40 extending from the inner tube 10 onto which a Presta valve 18 or a Schrader valve 26 connects. This embodiment is shown in FIG. 3. The semi-stem 40 can be both externally and internally threaded, thus defining an exterior male engagement surface 42 and an interior female engagement surface 44. A semi-stem 40 having both a male engagement surface 42 and a female engagement surface 44 may be used to selectively engage two different styles of inflation valve 18, 26 as described above. In particular, a Schrader valve 26 may be formed with a threaded female socket 46 as shown in FIG. 3. The Schrader valve 26 may be selectively and removably engaged with the male engagement surface 42 of the semi-stem 40. The connection between the semi-stem 40 and the Schrader valve 26 may be made airtight with the use of a seal. A seal may be a separate element such as an o-ring 48 as shown in FIG. 3. Alternatively, the seal may be a compound or material applied to the threaded engagement between the Schrader valve 26 and the semi-stem 40. A suitable seal may be accomplished by machining the respective threads with sufficient precision to assure an airtight seal, or by applying tape, sealant, or a compound to the threads prior to the threaded engagement.

A second type of valve, in particular a Presta valve 18, may be selectively connected to the semi-stem 40. As shown in FIG. 3, a removable Presta valve 18 may have an attachment structure 36 featuring a male threaded portion 50 configured to selectively and removably engage with the female engagement surface 44 of the semi-stem 40. An airtight seal between the male threaded portion 50 of the Presta valve 18 and the female engagement surface 44 may be formed with a seal as described above. Thus, the semi-stem embodiment, like the threaded aperture embodiment described above, provides for the interchangeable use of at least two distinct styles of bicycle valve with the same inner tube.

The multiple types or styles of inflation valves suitable for attachment to an inner tube 10 consistent with the present invention are described above as a Presta and Schrader valve. It is important to note that the inner tube 10 of the present invention is also suitable for use with different sizes of the same types of valve. For example, a user may selectively attach a long Presta valve or a short Presta valve to his inner tube, depending upon the configuration of the user's bicycle rim. Thus, “two different styles of inflation valve” as used herein encompasses both valves of different types, such as Presta and Schrader, and valves of the same type, but of different sizes.

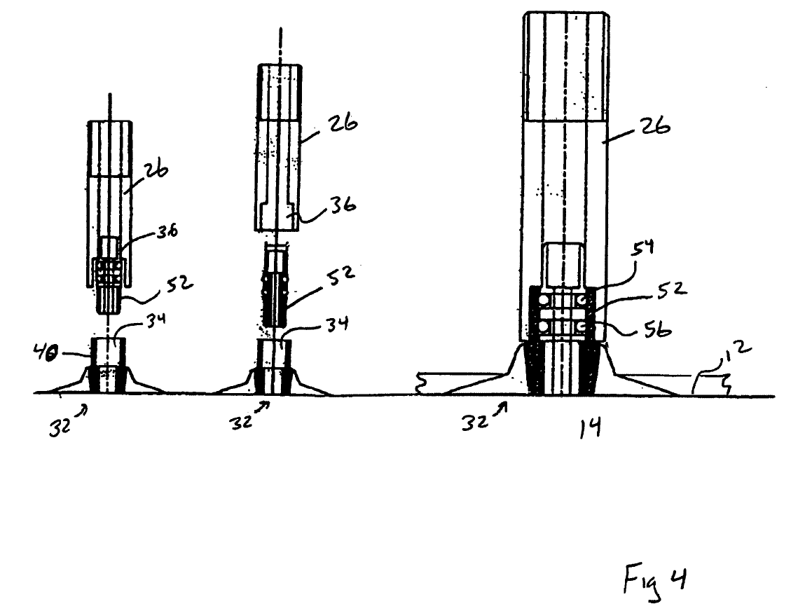

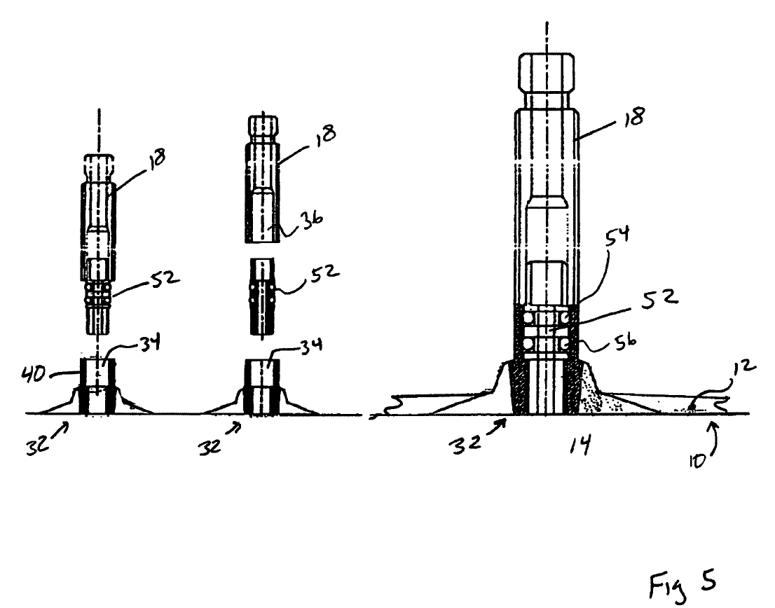

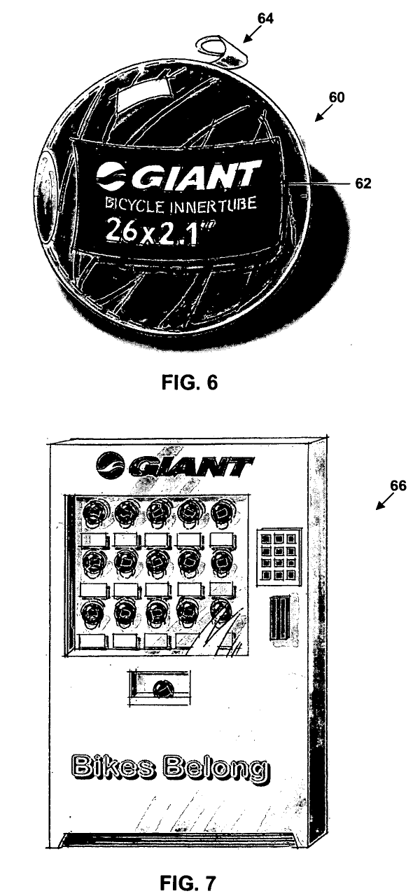

An alternative embodiment of a bicycle inner tube 10 consistent with the present invention is shown in FIG. 4 and FIG. 5. The embodiments of FIG. 4 and FIG. 5 each feature a connecting means 32 which is a threaded aperture 34. In this embodiment, the threaded aperture 34 is included in a semi-stem 40. In addition, the embodiment of FIG. 4 and FIG. 5 includes a hollow threaded stud 52 which is configured to be installed in removable, threaded engagement with the threaded aperture 34. An inflation valve, which may be a Presta valve 18 or a Schrader valve 26, is also provided in removable, threaded engagement with the hollow threaded stud 52 such that substantially airtight fluid communication exists between the interior gas compartment 14 of the annular envelope 12 of an inner tube 10.

The inner tube 10 and valve 18, 26 of FIG. 4 and FIG. 5 also features a seal between the threaded aperture 34 and the hollow threaded stud 52 and between the hollow threaded stud 52 and the Presta valve 18 or Schrader valve 26. In FIG. 4 and FIG. 5, the respective seals between these components are shown as first and second 0-rings 54, 56 (respectively) operatively associated with the hollow threaded stud 52. Other seals, including the use of sealing compounds or tapes as described above, may be employed as an alternative to o-rings, gaskets, or other mechanical seals.

FIG. 4 shows a Schrader valve 26 having an attachment structure 36 configured to engage with the hollow threaded stud 52. Similarly, FIG. 5 shows a Presta valve 18 having an attachment structure 36 configured to engage with the same hollow threaded stud 52. Thus, either of these two types of bicycle valves 18, 26 or valves 18, 26 of different sizes may be interchangeably attached to the attachment structure 36 of an inner tube 10 consistent with the present invention.

Another aspect of the present invention is a method of providing a bicycle inner tube 10 and valve 18, 26. The method includes providing an inner tube 10, such as that shown in FIGS. 2-5, associated with connecting means 32. In addition, first and second styles of inflation valves, which may be a Presta valve 18 or Schrader valve, another type of bicycle inflation valve, or various sizes of valves, are provided. The valves 18, 26 provided are operatively associated with an attachment structure 36 configured to be selectively engaged with the connecting means 32 of an inner tube 10 such that substantially airtight fluid communication between the interior of the inner tube 10 and the inflation valve 18, 26 is accomplished as described above. Typically, the inner tube 10 and first and second inflation valves 18, 26 will be provided to consumers as separate items for purchase. Thus, a consumer may select from and interchange between a wide variety of available styles and sizes of tubes and matching valves.

The use of a tube which accepts a replaceable and interchangeable inflation valve affords benefits to the bicycle owner and technician. In particular, bicycle inner tubes are commonly damaged or punctured when riding. Thus, the owner of a bicycle must occasionally replace his or her inner tube. Typical prior art inner tubes require that a valve which is operating perfectly well be thrown out with a damaged inner tube, since the two are permanently bonded together. Similarly, the owner of a bicycle who must replace a damaged valve is presently required to also replace what may be a perfectly good inner tube. The present invention can, therefore, result in significant cost and resource savings, as well as adding user flexibility. In addition, interchangeable valves allow the user to select either Presta or Schrader valves for his or her use. Thus, the need for multiple pumps or adapters between pump head styles is eliminated. Furthermore, families or groups having several bicycles can select a unified valve style to simplify routine tire inflation operations.

The present invention also provides a bicycle component supplier or retailer with unique distribution and marketing opportunities.

The inner tubes of the present invention can also be packaged in small stuffed socks, containers recycled from old inner tubes, in cans, or in other nontraditional packaging apparatus.

As discussed above, the present invention features inner tubes having a connecting means 32 suitable for mating with an appropriate valve. Preferably, the tubes and appropriate valves can be distributed separately to retail customers.

Since the inner tubes of the present invention can be packaged and distributed without valves, the tubes are suitable to unique packaging methods. In one embodiment shown in FIG. 9, the tube is packaged in a transparent, substantially spherical conforming package 60. Conforming packages could also be elliptical, cylindrical or of a novelty configuration. The conforming package 60 can be an appropriately sized plastic sphere or a shrink-to-fit container. A shrink to fit container can be fabricated by placing the inner tube into an oversized appropriately shaped container made of heat shrinkable polymer or thermoplastic, and applying heat until the package tightly conforms to the tube. Other packaging techniques such as vacuum packing can be employed to create a conforming package 60. The conforming package could be fabricated from an elastic material, a mesh or preferably an environmentally friendly recycled material. Since the tubes of the present invention are preferably marketed without valves attached, there is no risk of damage to the rubber annular envelope 12 when the tube is compressed tightly in a conforming package 60. Alternatively, conforming packaging 60 can tightly bond a prior art tube during storage in a bicycle repair kit, and thus protect the prior art tube from valve abrasion or valve damage.

The conforming package 60 will preferably feature sizing information and a source identifier or other marketing materials 62. The conforming package 60 can be opened by pulling a tab 64. The conforming package 60, since it tightly compresses a tube will be more compact than a typical prior art boxed inner tube. Thus, it is more likely that the purchaser of a tube will place the packaged tube in his or her saddle bag, thus maintaining the source identifier or other marketing information 62. Furthermore, the conforming package 60 protects the tube while carried by a used on rides.

The appealing spherical or other shaped packaging of the embodiment shown in FIG. 9 allows the implementation of various non-traditional distribution methods. For example, the tubes of the present invention may be distributed through a cash or credit operated vending machine 66 as shown in FIG. 7. Such a machine would allow a tube purchaser to select, pay for, and receive an appropriately sized inner tube without requiring assistance from retail shop personnel. Such a machine also would allow the distribution of tubes to perspective customers outside of regular business hours. The vending machine 66 preferably would also be configured to distribute valves of various types for mating engagement with the inner tubes, small tools, CO₂ cartridges, patch kits, and similar items. Preferably, the machine would be portable, allowing a bicycle shop or manufacturer to take the machine to bicycling events.

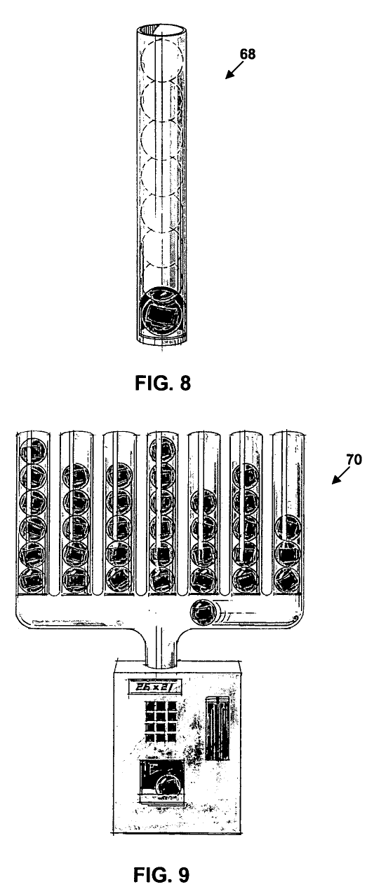

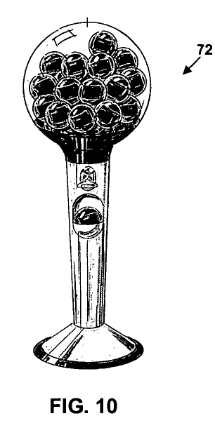

In addition to the vending machine 66 of FIG. 7, the conforming packaging 60 of the present invention allows for in-store distribution in stacked tubes 68 as shown in FIG. 8 or, preferably, an automated tube hopper dispensing device 70 as shown in FIG. 9. Similarly, the spherical conforming packaging 60 could be distributed from a gumball style dispensing machine 72 as shown in FIG. 10. The interactive distribution methods described above will allow a purchaser of inner tubes to more thoroughly enjoy the purchase of what is basically a utilitarian object, thus increasing store visits and sales, and decrease staff time presently dedicated to tube sales.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims.

What is claimed is:

1. A bicycle inner tube comprising:
an annular envelope defining an interior gas compartment; and
connecting means operatively associated with the annular envelope, the connecting means being configured to selectively engage with either of at least two different styles of inflation valve with the selective engagement providing for substantially air tight fluid communication between the interior gas compartment and the selected inflation valve.

2. The bicycle inner tube of claim 1 wherein the connecting means comprises a threaded aperture formed in the annular envelope configured to selectively threadably engage an attachment structure associated with each of the at least two different styles of inflation valve.

3. The bicycle inner tube of claim 2 further comprising a seal operatively associated with the threaded aperture.

4. The bicycle inner tube of claim 3 wherein the connecting means further comprises a hollow threaded stud in removable threaded engagement with the threaded aperture and configured to selectively threadably engage an attachment structure associated with each of the at least two different styles of inflation valve.

5. The bicycle inner tube of claim 1 wherein the connecting means comprises a threaded semi-stem configured to selectively threadably engage an attachment structure associated with each of the at least two different styles of inflation valve.

6. The bicycle inner tube of claim 5 wherein the threaded semi-stem is threaded on an exterior male engagement surface and an interior female engagement surface.

7. The bicycle inner tube of claim 5 further comprising a seal operatively associated with the threaded semi-stem.

8. A bicycle inner tube comprising:
an annular envelope defining an interior gas compartment;
a threaded aperture opening through the annular envelope;
a hollow threaded stud in removable threaded engagement with the threaded aperture; and
an inflation valve in removable threaded engagement with the hollow threaded stud, such that substantially air tight fluid communication exists between the interior gas compartment and the inflation valve.

9. The bicycle inner tube of claim 8 further comprising a seal between the threaded aperture and the hollow threaded stud.

10. The bicycle inner tube of claim 8 further comprising a seal between the hollow threaded stud the inflation valve.

11. The bicycle inner tube of claim 8 wherein the inflation valve is a Presta style valve.

12. The bicycle inner tube of claim 8 wherein the inflation valve is a Schrader style valve.

13. The bicycle inner tube of claim 8 wherein the threaded aperture is formed in a semi-stem.

14. A method of providing a bicycle inner tube and valve comprising:
providing an inner tube operatively associated with a connecting means;
providing an inflation valve of a first style operatively associated with an attachment structure configured to be selectively engaged with the connecting means providing for substantially air tight fluid communication between the interior of the inner tube and the inflation valve; and
providing an inflation valve of a second style operatively associated with an attachment structure configured to be selectively engaged with the connecting means providing for substantially air tight fluid communication between the interior of the inner tube and the inflation valve.

15. The method of claim 14 wherein the inner tube and first and second inflation valves are provided to consumers as separate items for purchase.

16. The method of claim 14 wherein the connecting means comprises a threaded aperture formed in the inner tube configured to selectively threadably engage an attachment structure associated with each of the first and second styles of inflation valve.

17. The method of claim 16 wherein the inner tube further comprising a seal operatively associated with the threaded aperture.

18. The method of claim 17 wherein the connecting means further comprises a hollow threaded stud in removable threaded engagement with the threaded aperture.

19. The method of claim 14 wherein the connecting means comprises a threaded semi-stem configured to selectively threadably engage an attachment structure associated with each of the first and second styles of inflation valve.

20. The method of claim 19 wherein the threaded semi-stem is threaded on an exterior male engagement surface and an interior female engagement surface.
